(19) United States
(12) Patent Application Publication
(10) Pub. No.: US 2006/0151038 A1
(43) Pub. Date: Jul. 13, 2006

(54) Coiled air brake hose assembly

(75) Inventor: Glenn M. Gregrich, Stow, OH (US)

Correspondence Address: LARSON NEWMAN ABEL POLANSKY & WHITE, LLPL., 5914 WEST COURTYARD DRIVE, SUITE 200, AUSTIN, TX, 78746, US

(73) Assignee: SAINT-GOBAIN PERFORMANCE PLASTICS CORPORATION

(21) Appl. No.: 11/035,389

(22) Filed: Jan. 13, 2005

(51) Int. Cl. F16L 11/00

(52) U.S. Cl. 138/109; 285/242

(57) ABSTRACT

The disclosure is directed to a coiled air brake hose assembly including a coiled hose having a terminal end and defining a lumen. The coiled air brake hose assembly also includes a fitting molded over the hose at the terminal end and providing access to the lumen. The fitting conforms to and bonds to an outer surface of the coiled hose.

### FIELD OF THE DISCLOSURE

This disclosure, in general, relates to coiled air brake hoses and assemblies and method for making same.

### BACKGROUND

Transportation of goods and cargo represents a large portion of global and regional economies. Goods and cargo are transported by planes, trains, and tractor/trailer trucks. However, the transportation industry is known for low margins and high volume. As such, competitors within the transportation industries are cost and revenue conscious.

Cost and revenue are influenced by the weight and durability of the transport vehicles. Exemplary costs include fuel and maintenance. Each pound weight of a vehicle increases fuel consumption and wear on a vehicle. Revenue is also affected by weight. Each pound of additional cargo that may be transported leads to increased revenue. As such, transportation companies attempt to reduce the weight of vehicles while simultaneously retaining durability of replaced parts.

To reduce the weight, manufacturers of transportation vehicle parts have looked to reduce the weight associated with vehicle parts. Every part is scrutinized, including hose assemblies, such as coiled air brake hose assemblies. Traditional hoses include an assembly of spring nuts, compression nuts, inserts and ferrules. These parts are typically formed from metal and as such, are heavy.

However, replacing such parts is not trivial. The replacements are desirably durable, resistant to strain, and resistant to chemical exposure, such as exposure to zinc chloride. As such, improved coiled air brake hose assemblies would be desirable.

### SUMMARY

In one particular embodiment, the disclosure is directed to a coiled air brake hose assembly including a coiled hose having a terminal end and defining a lumen. The coiled air brake hose assembly also includes a fitting molded over the hose at the terminal end and providing access to the lumen. The fitting conforms to and bonds to an outer surface of the coiled hose.

In another embodiment, the disclosure is directed to a method for forming a coiled air brake hose assembly. The method includes forming a coiled hose. The coiled hose has a terminal end and defines a lumen. The method further includes molding a fitting over the terminal end of the coiled hose. The fitting conforms to and bonds to an outer surface of the coiled hose.

In a further embodiment, the disclosure is directed to a coiled air brake hose assembly including a multi-layer hose having a terminal end and forming a lumen. The coiled air brake hose assembly also includes a strain relief component overlying at least a portion of the terminal end of the multi-layer hose and a fitting molded over the terminal end and conforming to a contour of the strain relief component and the multi-layer hose. The fitting provides access to the lumen.

### BRIEF DESCRIPTION OF THE DRAWINGS

The present disclosure may be better understood, and its numerous features and advantages made apparent to those skilled in the art by referencing the accompanying drawings.

FIG. 1 includes a diagram illustrating an exemplary embodiment of a coiled air brake hose assembly.

FIGS. 2, 3, 4, 5, and 6 include diagrams illustrating exemplary embodiments of fitting assemblies.

FIG. 7 includes a flow diagram illustrating an exemplary method for forming a coiled air brake hose.

FIG. 8 includes a diagram illustrating an exemplary transport vehicle.

The use of the same reference symbols in different drawings indicates similar or identical items.

### DETAILED DESCRIPTION OF THE DRAWINGS

In one particular embodiment, the disclosure is directed to a coiled air brake hose assembly, which may be used in the transportation industry on transport vehicles, such as trucks, trailers, and trains. Embodiments of the coiled air brake hose assembly generally include a coiled hose having a terminal end and defining a lumen. In one embodiment, the assembly also includes a fitting molded over the hose at the terminal end and providing access to the lumen. The fitting conforms to and bonds to an outer surface of the coiled hose. In one exemplary embodiment, the coiled hose is a multi-layer polyamide hose. The coiled air brake hose assembly may further include a strain relief component, such as a metal or polymeric spring or tube, located on the outside surface of the coiled hose. The strain relief component may be at least in part overmolded by the fitting or overlie a portion of the overmolded fitting. The terminal end of the coiled hose may be straight.

In another exemplary embodiment, the disclosure is directed to a method for forming a coiled air brake hose. The method includes forming a coiled hose, for example, by cutting, winding and heating the hose when it is wrapped around a mandrel. The method further includes forming a fitting over a terminal end of the coiled hose. The fitting bonds to and conforms to an outer surface of the coiled hose at the terminal end. The method may further include providing a strain relief component along the terminal end and forming the fitting over the terminal end of the coiled hose and at least a portion of the strain relief component. Alternatively, the strain relief component may be a molded component.

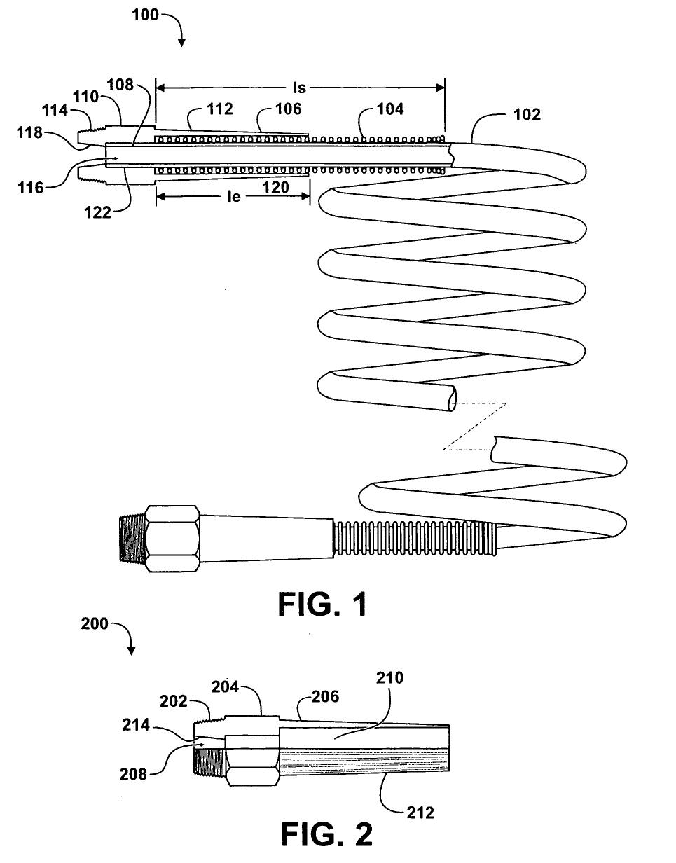

FIG. 1 illustrates an exemplary embodiment of a coiled air brake hose assembly 100. The coiled air brake hose assembly 100 includes a coiled hose 102 having a plurality of coils and a straight terminal end 120. The coiled air brake hose assembly 100 also includes a fitting 106 molded over the end of hose 102. In addition, the coiled air brake hose may include a strain relief component 104, embodied in FIG. 1 as a spring, having a length lₛ. Length lₛ may, for example, be equal to the length of the straight terminal end plus or minus about 1.5 inches. When offset from the terminal end, the strain relief component may extend along the first coil of the hose, such as about 1.5 inches along the first coil.

In the exemplary embodiment illustrated, the hose 102 defines a lumen 116 that is accessible via the fitting 106. The overmolded fitting 106 is a single monolithic component and is formed to bond to and conform to the shape of the hose 102 and, optionally, the strain relief component 104. In one exemplary embodiment, the hose 102 extends beyond a terminal end of the strain relief component 104, leaving a portion 108 near the terminal end that directly contacts the overmolded fitting 106.

The overmolded fitting 106 may include a coupling portion 114 that extends to the distal end 122 and has an inner surface 118 that defines an opening providing access to the lumen 116 of hose 102. The overmolded fitting may also include a nut 110 and a handle extension 112. The nut 110 may be formed to conform to a wrench or have a wing nut configuration. The handle extension 112 may function as a gripping area for a gladhand connection and/or may function as an extended relief guard. In the illustrated embodiment, the extension 112 covers and conforms to the surface of at least a portion of the strain relief component 104. More particularly, in the embodiment illustrated, the extension 112 has an overlap portion 120 having a length lₑ that corresponds to that portion of the extension that overlies the strain relief component 104. Typically, the extent of overlap is significant, such that lₑ is at least 0.15 lₛ, oftentimes at least 0.2 lₛ, at least 0.25 lₛ, or at least 0.30 lₛ. Alternatively, the strain relief component may overlie the overlap portion 120 of the overmolded fitting 106.

The coupling portion 114 of the overmolded fitting 106 is depicted as a threaded pipe fitting for engagement with a complimentary structure. However, the coupling portion 114 may take various forms including threading and compression couplings. In other exemplary embodiments, the coupling portion 114 may be shaped to form a CAM fitting, threaded fitting (NPT, UNF or BSP), gladhand fitting, compression fitting, or quick connect fitting. In one particular embodiment, the coupling portion 114 is configured as a quick connect coupling conforming to the SAE J2044 standard, for example, a male quick connect joint.

The hose 102 may be a single layer hose or a multi-layer hose, although multi-layer hoses are preferred for certain applications. In one exemplary embodiment, the hose 102 is formed of polyamide, such as nylon 6, nylon 6,6, nylon 6,9, nylon 6,12, nylon 6, 11, nylon 11, nylon 12, and combinations, blends and copolymers thereof. In an exemplary multi-layer hose, the hose 102 includes an outer layer formed of a polymer selected from a group consisting of polyamide, such as nylon 11 or nylon 12, polyurethane, polyester (homo and copolymers thereof), polyolefin, and alloy, blends, and copolymers thereof. The hose also includes an innermost layer formed of polyamide. The hose 102 may further include internal layers formed of modified polyolefins, polyurethanes, polyesters, polyamides, and combinations, copolymers and blends thereof. The hose may further include an internal reinforcement layer, such as a layer formed of fibers formed of polyester, polyaramid, or polyamide. One exemplary embodiment of a hose 102 is described in U.S. Pat. No. 6,670,004 issued Dec. 30, 2003 to inventor Edward A. Green, included herein by reference.

The strain relief component 104 may be formed of a solid tubular material, a spring formed of a helix, such as a helically coiled wire, or other geometric configurations, such as a mesh or woven structure configured to have a circular cross section to match the outer contour of the hose. In one exemplary embodiment, the strain relief component is a spring formed of a metal or metal alloy, such as brass or steel. In an alternative embodiment, the strain relief component 104 may be a polymeric tube or a spring formed of a polymeric material.

The overmolded fitting 106 may be formed of filled polymeric material, that is, a polymer including a filler. For example, the polymeric material may include polyamide, such as nylon 6,9, nylon 6,11, nylon 6,12, nylon 11 and nylon 12, polyurethane, polyester (e.g. homo and copolyesters), polyolefin, such as modified polyolefins (e.g. maleic anhydride modified polyolefin), and alloys, blends and copolymers thereof. In one particular embodiment, the polymeric material is selected to be compatible with an outer layer of the hose 102. For example, when the outer layer of the hose 102 is formed of nylon 6,12 alloy, nylon 6,12 copolymer, or nylon 12, the overmolded fitting 106 may be formed of nylon 12, a copolymer including nylon 12, or a modified polyolefin.

Exemplary fillers include ceramic, nanoclay, carbon, or polymer. For example, ceramic materials may include glass, silica, zirconia and alumina. Polymeric materials include polyaramids. The filler may be in particulate form or fiberous form, including filament and cut fiber forms. For example, the filler may include a disperse polymer phase of polyimide. The filler may be incorporated in amounts of 1 to about 50 weight percent, such as about 10 to about 40 weight percent, about 15 to about 30 weight percent, or about 20 to about 25 weight percent. In one particular embodiment, a glass filled polyamide nylon 12 polymer matrix including approximately 23 weight percent cut glass filler is overmolded over a multilayer hose including an outer layer of nylon 12 or nylon 6,12.

FIG. 2 included a diagram of another exemplary embodiment of an overmolded fitting 200. The overmolded fitting 200 includes a coupling portion 202, a nut 204, and a handle 206. In this exemplary embodiment, the handle 206 has a tapered structure, diminishing in thickness with longitudinal distance from the coupling portion 202. In addition, the handle 206 may include fins, ribs or longitudinal protrusions 212. Such longitudinal protrusions may provide additional structural support or provide an improved surface for gripping. In an alternative embodiment, the handle 206 may include latitudinal, circumferential, or helical protrusions.

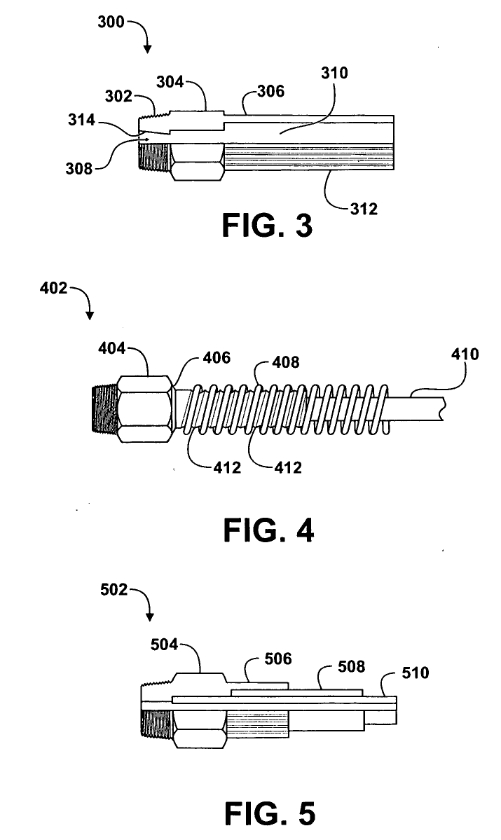

FIG. 3 illustrates another exemplary embodiment of an overmolded fitting 300. The overmolded fitting 300 includes a coupling portion 302, a nut 304, and a handle 306. In this exemplary embodiment, the handle 306 has a constant thickness as it extends longitudinally from the terminal end. The handle 306 may also include longitudinal protrusions, fins or ribs 312.

Alternatively, the overmolded fitting may latitudinal ribs, barbs or ridges that engage a spring or tube strain relief component partially overlapping the outside of the fitting. FIG. 4 illustrates an embodiment, in which extension 406 of fitting 402 extends longitudinally from the nut 404. Ridges or barbs 412 along outer contour of the extension 406 may engage a strain relief component 408, such as a spring or tube. The strain relief component further extends along hose 410.

In another example, the strain relief component may include a tube, such as a polymeric tube. FIG. 5 illustrates an exemplary embodiment in which a tubular strain relief component 508 extends along hose 510. The strain relief component 508 may be preformed and the hose 510 inserted into the strain relief component 508. Alternately, the strain relief component 508 may be molded on to the hose 510. The strain relief component 508 may be formed of polymer materials, such as polyamide, polyolefin, such as modified and unmodified polyolefin, polyurethane, polyesters (homo and copolymers thereof), and alloys, blends, and copolymers thereof. When the strain relief component is molded to the hose 510 or is overmolded by a fitting 502, the strain relief component 508 is generally formed of materials compatible with those of the hose 510 and/or the fitting 502. The strain relief component may further include filler, such as particulate or fibrous filler formed of ceramics, glass, carbon, or polymeric materials.

The fitting 502 may be molded over the hose 510. In this exemplary embodiment, the fitting 502 is illustrated as having a handle 506 extending longitudinally from a nut 504. The handle 506 partially overlies the strain relief component 508.

Alternatively, the strain relief component 508 may have perforations or holes in the region over which the handle 506 is molded. The fitting 502 may extend through the perforations or holes and bond to the hose 510. As such, the strain relief component 508 is mechanically restrained. The material forming the strain relief component 508 may or may not be compatible with the material forming the fitting 502. In another example, a mechanical restraint may be formed through loosely wound spring-type strain relief components.

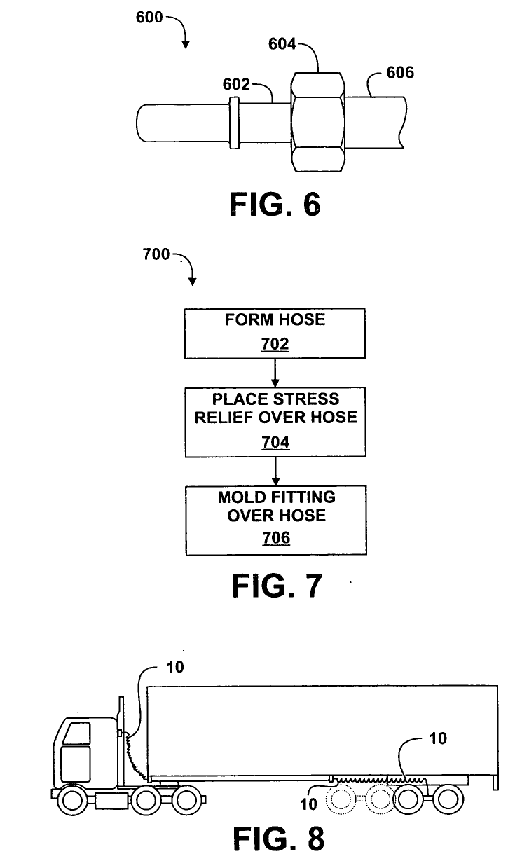

While the coupling portions illustrated in FIGS. 1-5 are illustrated as threaded couplings, the coupling portions may alternatively include compression fittings, quick connect fittings, gladhand fittings or CAM fittings. FIG. 6 illustrates an exemplary embodiment of an overmolded fitting 600 that includes a coupling end 602 configured as a male fitting in compliance with SAE J2044. The fitting may further include the nut 604 and handle 606.

In one exemplary embodiment, the coiled air brake hose assembly is formed by method 700 of FIG. 7. A hose is formed, as shown at 702. For example, a multi-layer hose may be wrapped around a mandrel and heated to impart a coil configuration to the hose. The hose may also include straight portions near the terminal ends of the hose. In one exemplary embodiment, a polyamide hose is helically wound around a mandrel and heated at about 200° F. to about 300° F. for about 5-90 minutes.

Optionally, a strain relief component is placed over the hose, as shown at 704. For example, a straight portion of the hose near the terminal end may be threaded through a strain relief component. In one particular embodiment, the hose is threaded through the strain relief component to leave an exposed terminal end portion. Alternatively, the strain relief component may be molded to the hose.

The terminal end of the hose, including the optional strain relief component, is inserted into a mold and a fitting is overmolded over the hose and optionally at least a portion of the strain relief component, as shown at 706. The overmolded fitting forms a single monolithic component that conforms to the contours of the hose and at least the portion of the strain relief component. In one particular embodiment, the over-molded fitting bonds to a terminal portion of the hose and the strain relief component. In another embodiment, the strain relief can be threaded over the outside of the overmolded fitting or, if plastic, over the outside of a barb.

The coiled air brake hose assembly may be used in conjunction with air brake systems on transport vehicles. FIG. 8 illustrates exemplary transport vehicles including a tractor truck and trailer. The coiled air brake hose assembly 10 may be used to couple air brake systems between vehicles or within a vehicle.

In particular embodiments, the coiled air brake hose assembly and methods for making and using same are particularly advantageous. For example, the coiled air brake hose assembly exhibits considerable leak resistance and protection from external exposure to corrosive chemicals, such as zinc chloride, calcium chloride, copper chloride, and magnesium chloride. In a further exemplary embodiment, the assembly exhibits considerable tensile strength when exposed to longitudinal forces.

According to some aspects of the above embodiments, the coiled air brake hose assembly is durable and light. Prior art metal fittings sacrifice durability and strength when reduced in size and weight.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

1. A coiled air brake hose assembly comprising:
a coiled hose having a terminal end and defining a lumen; and
a fitting molded over the hose at the terminal end and providing access to the lumen, the fitting conforming to and bonding to an outer surface of the coiled hose.

2. The coiled air brake hose assembly of claim 1, wherein the hose includes an outer layer formed of polyamide.

3. The coiled air brake hose assembly of claim 1, wherein the hose is a mono-wall hose.

4. The coiled air brake hose assembly of claim 1, wherein the hose is a multilayer hose.

5. The coiled air brake hose assembly of claim 1, further comprising a strain relief component.

6. The coiled air brake hose assembly of claim 5, wherein the strain relief component has a length lₛ, and the fitting has an extension having a length lₑ that extends over and is bonded to a portion of the strain relief component.

7. The coiled air brake hose assembly of claim 6, wherein lₑ is at least 0.15 lₛ.

8. (canceled)

9. (canceled)

10. The coiled air brake hose assembly of claim 5, wherein the strain relief component comprises a spring.

11. (canceled)

12. (canceled)

13. The coiled air brake hose assembly of claim 1, wherein the fitting comprises polymer and filler.

14. (canceled)

15. (canceled)

16. (canceled)

17. The coiled air brake hose assembly of claim 13, wherein the filling comprises glass fibers.

18. (canceled)

19. (canceled)

20. The coiled air brake hose assembly of claim 13, wherein the filling comprises a ceramic particulate.

21. The coiled air brake hose assembly of claim 13, wherein the filling comprises a dispersed polymer phase.

22. (canceled)

23. (canceled)

24. (canceled)

25. The coiled air brake hose assembly of claim 1, wherein the fitting includes an integrally formed nut.

26. (canceled)

27. The coiled air brake hose assembly of claim 1, wherein the fitting includes a ribbed strain guard portion.

28. The coiled air brake hose assembly of claim 1, wherein the coiled hose includes a plurality of coils, the terminal end being straight.

29. The coiled air brake hose assembly of claim 1, wherein the fitting is a single monolithic component.

30. The coiled air brake hose assembly of claim 1, wherein the fitting has a coupling portion for engaging a complementary structure.

31. (canceled)

32. (canceled)

33. A method for forming a coiled air brake hose assembly, the method comprising:
forming a coiled hose, the coiled hose having a terminal end and defining a lumen; and
molding a fitting over the terminal end of the coiled hose, the fitting conforming to and bonding to an outer surface of the coiled hose.

34. The method of claim 33, further comprising:
placing a strain relief component around the outer surface of the coiled hose, wherein the fitting is molded over the terminal end of the coiled hose and the strain relief component.

35. (canceled)

36. (canceled)

37. A coiled air brake hose assembly comprising:
a multi-layer hose having a terminal end and forming a lumen;
a strain relief component overlying at least a portion of the terminal end of the multi-layer hose; and
a fitting molded over the terminal end and conforming to a contour of the strain relief component and the multi-layer hose, the fitting providing access to the lumen.

38. The coiled air brake hose of claim 37, wherein the multi-layer hose includes a polyamidean outer layer comprising a polymer selected from a group consisting of polyamide, polyurethane, polyester and polyolefin.

39. The coiled air brake hose of claim 37, wherein the strain relief component includes a spring.

40. (canceled)

41. (canceled)

42. (canceled)

43. (canceled)

44. (canceled)

45. (canceled)

46. (canceled)

47. (canceled)

48. (canceled)

49. (canceled)
